(19) United States
(12) Patent Application Publication
(10) Pub. No.: US 2026/0220424 A1
(43) Pub. Date: Jul. 30, 2026

(54) RECURRENT INTERFACE NETWORKS

(71) Applicant: Google LLC, Mountain View, CA (US)

(72) Inventors: Ting Chen, Mountain View, CA (US); David James Fleet, Toronto (CA); Allan Anwar Jabri, Tiburon, CA (US)

(21) Appl. No.: 19/142,544

(22) PCT Filed: Dec. 22, 2023
(86) PCT No.: PCT/US2023/085784

§ 371 Date: Jun. 23, 2025

Related U.S. Application Data
(60) Provisional application No. 63/434,923, filed on Dec. 22, 2022.

(51) Int. Cl. G06N 3/044; G06N 3/045; G06N 3/08

(52) U.S. Cl. CPC G06N 3/044; G06N 3/045; G06N 3/08

(57) ABSTRACT

Methods, systems, and apparatus, including computer programs encoded on computer storage media, for processing network inputs using recurrent interface networks.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that processes inputs using a recurrent interface network.

The recurrent interface network is a neural network that includes a sequence of neural network blocks that each update a set of interface vectors that are derived from an input to the neural network. In particular, each block updates the set of interface vectors using a set of latent vectors, with the number of latent vectors in the set being independent from the number of interface vectors in the set of interface vectors. In particular, the number of latent vectors in the set is generally smaller than the number of interface vectors in the set.

Throughout this specification, an embedding refers to an ordered collection of numerical values, e.g., a vector or matrix of numerical values. Thus, an embedding vector is a vector of numerical values that, e.g., represents an entity or a portion of an entity.

A block refers to a group of one or more neural network layers in a neural network.

Particular embodiments of the subject matter described in this specification can be implemented so as to realize one or more of the following advantages.

This specification describes a neural network architecture (the Recurrent Interface Network (“RIN”) that allocates computation adaptively to the input according to the distribution of information within the input, allowing the system to scale to tasks that require generating or otherwise operating on high-dimensional data in a memory and compute efficient manner.

Hidden units of RINs are partitioned into the interface, which is locally connected to inputs, and the latents, which are decoupled from inputs and can exchange information globally. Each RIN block selectively reads from the interface into latents for high-capacity processing, with incremental updates written back to the interface.

Stacking multiple RiN blocks in a sequence enables effective routing across local and global levels. While this routing adds overhead, the cost can be amortized in recurrent computation settings where inputs change gradually while more global context persists, such as iterative generation using diffusion models. To this end, the system can optionally apply a latent self-conditioning technique that “warm-starts” the latents at each iteration of the generation process using the latents from the preceding iteration of the generation process.

In other words, in order to reduce memory consumption, RINs focus the bulk of computation on a set of latent vectors, the number of which is generally many times fewer than the number of interface vectors, and use lightweight read and write neural networks to read and write (i.e. route) information between latent and interface vectors. Stacking RIN blocks allows bottom-up (data to latent) and top-down (latent to data) feedback, leading to deeper and more expressive routing. For example, if there are 1024, 2048, 4096, or even 16384 interface vectors, e.g., when the inputs are images or videos and each interface vector represents a patch from the image or video, the set of latent vectors can include only 128 or 256 vectors, ensuring that the bulk of the computation performed by each RiN block occurs in the much smaller dimensional space of latent vectors. Thus, the latent space provides a compressed representation and the bulk of the computations operate in this compressed space. The number and/or dimensionality of the latent vectors may be adapted to the memory resources available on the underlying hardware the RiN is implemented on. The RiN is able to perform tasks that require scaling to high-dimensional data in a computational and memory efficient manner. By having a limited space of latents, the RiN can be more computational and memory efficient than state-of-the-art modeling techniques, e.g., those that rely on U-Nets or other convolutional architectures, even when operating on (or generating) higher-resolution data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for generating a network output at a given time step.

FIG. 3 shows an example of a computation graph of a recurrent interface network.

FIG. 4 shows an example using a recurrent interface network with six blocks to generate an image.

FIG. 5 shows the performance of a recurrent interface network.

Like reference numbers and designations in the various drawings indicate like elements.

### DETAILED DESCRIPTION

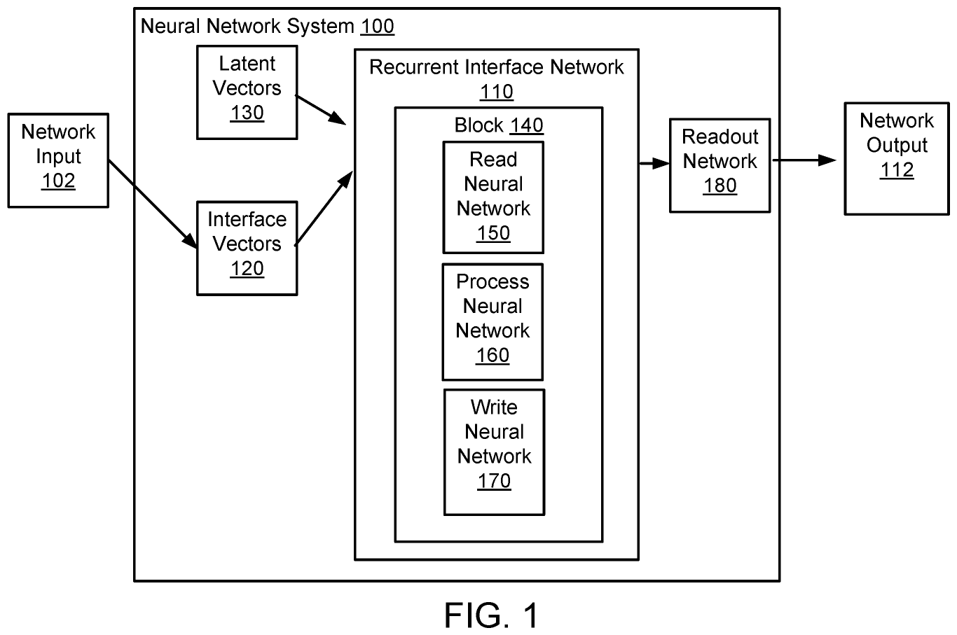

FIG. 1 shows an example neural network system 100. The neural network system 100 is an example of a system implemented as computer programs on one or more computers in one or more locations, in which the systems, components, and techniques described below can be implemented.

The neural network system 100 is a system that generates a respective network output 112 at each time step of a sequence of one or more time steps using a recurrent interface network 110.

In particular, at each time step, the system 100 obtains a network input 102 for the time step and generates a network output 112 for the time step using the recurrent interface network 110.

The network input 102 at each time step is a collection of data elements, e.g., a sequence of data elements, an unordered set of data elements, a two-dimensional array of data elements, or a higher-dimensional array of data elements.

Examples of network inputs 102 for a given time step will be described below.

The network output 112 at each time step is also a collection of data elements and can have the same format as the network input 102 or a different format.

Examples of network outputs 112 for a given time step will be described below.

At any given time step, the system 100 generates, from at least the network input 102 for the time step, a set of interface vectors 120.

That is, the system 100 generates the set of interface vectors 120 at least in part by mapping the data elements in the network input 102 to a set of vectors. For example, the interface vectors 120 can include a respective interface vector corresponding to each of a plurality of subsets, e.g., overlapping or non-overlapping proper subsets, of the data elements in the network input 102. The system 100 can generate each of these interface vectors 120 by processing the corresponding subset of data elements using one or more learned transformations. The set of interface vectors 120 may be considered to be a set of embedding vectors, with at least some of the interface vectors 120 representing the network input 102.

As will be described in more detail below, the interface vectors 120 can optionally also include one or more additional vectors in addition those vectors that are generated by mapping the data elements in the network input 102.

The system 100 initializes a set of latent vectors 130 for the time step. Generally, the set of latent vectors 130 includes fewer latent vectors than the set of interface vectors 120. Moreover, the number of latent vectors in the set of latent vectors 130 is independent of the number of interface vectors 120 in the set of interface vectors 120 (and independent of the size of the network input 102).

The system 100 processes the interface vectors 120 and the latent vectors 130 using the recurrent interface network 110 to update the set of interface vectors 120.

The recurrent interface network 110 is a neural network that includes a sequence of neural network blocks 140 that are each configured to update the interface vectors 120 and the latent vectors 130. Thus, the output of the last neural network block 140 in the sequence is a set of updated latent vectors 130 and a set of updated interface vectors 120. As described in more detail below, the latent vectors 130 and the interface vectors 120 may be alternately updated.

Each neural network block 140 generally includes a read neural network 150, a process neural network 160, and a write neural network 170.

At each time step, each neural network block 140 processes the interface vectors 120 and the latent vectors 130 using the read neural network 150 to update the set of latent vectors 130. The read neural network 150 is configured to selectively read from the interface vectors 120 to update the latent vectors 130 to be input specific for the time step/network block.

The selective read from the interface vectors 120, which are initialized from the network input 102, carries information from the network input/interface vector space to the latent vector space and enables processing to be carried out in the latent vector space which is typically smaller than the interface vector space. This provides a compressive effect. The selective read focuses on the most relevant parts of the interface vectors 120 for processing at the time step/network block and enables dynamic allocation of computational resources to different parts of the input as required.

After processing the interface vectors 120 and the latent vectors 130 using the read neural network 150 to update the set of latent vectors 130, the block 140 processes the set of latent vectors 130 using the process neural network 160 to update the set of latent vectors 130.

The process neural network 160 provides the core computation of the neural network block. In one example, the computation(s) performed by the process neural network 160 comprises a self-attention operation. As noted above, the computation performed by the process neural network 160 occurs in the latent vector space and therefore requires fewer memory resources. In addition, as the latent vector space is decoupled from the input space, i.e., the size of latent vector space is independent of the size of the network input, there is improved scalability of the neural network, enabling processing of high-dimensional input data.

After processing the set of latent vectors 130 using the process neural network 160 to update the set of latent vectors 130, the block 140 processes the set of latent vectors 130 and the interface vectors 120 using the write neural network 170 to update the set of interface vectors 120.

Thus the write neural network 170 is configured to incrementally update the interface vectors 120 based upon the output of the processing phase (the process neural network 160). In this way, the interface vectors 120 are transformed toward a target/network output in a manner that uses fewer computational and memory resources.

That is, the first neural network block 140 in the sequence receives as input the interface vectors 120 generated from the network input and the initialized latent vectors 130. Each subsequent block in the sequence receives as input the interface vectors 120 after being updated by the preceding block and the latent vectors 130 after being updated by the preceding block.

After processing the interface vectors 120 and the latent vectors 130 through the recurrent interface network 110, i.e. through the sequence of neural network blocks 140, to update the set of interface vectors 120, the system 100 processes the set of interface vectors 120 using a readout neural network 180 to generate the network output 122 for the time step.

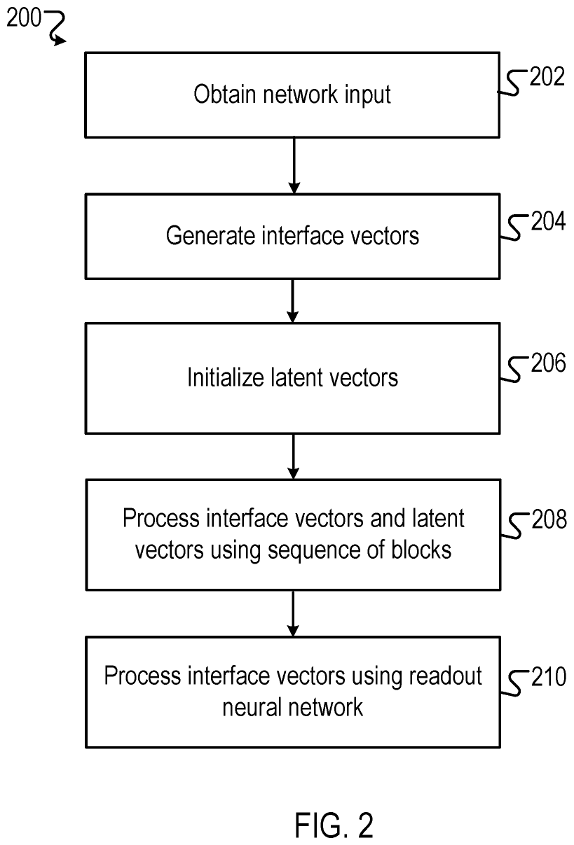

The operations performed by the blocks 140 in the sequence will be described in more detail below with reference to FIGS. 2-4.

The readout neural network 180 can generally be any appropriate neural network that is configured to map the set of interface vectors 120 to a collection of data elements that is in the format of the network output 112, i.e., to an output that has the required number of data elements for the network output 112. For example, the readout neural network 180 can be a set of one or more linear neural network layers that are applied independently to each interface vector 120, a multi-layer perceptron (MLP) that is applied independently to each interface vector 120, a Transformer neural network or recurrent neural network that is applied sequentially across the interface vectors 120, and so on.

Generally, the system 100 performs the sequence of time steps to generate a target output given the network input at the first time step.

In some implementations, there is only a single time step in the sequence. In these implementations, the network output at the time step defines the target output, i.e., is the target output or can be transformed into the target output.

In these implementations, the target output generated by the system can be a collection of data elements that represents any kind of entity.

The collection of data elements generated by the neural network can represent any appropriate entity.

For example, each data element can represent a pixel in an image, and the collection of data elements can collectively represent the image.

As another example, each data element can represent an audio sample in an audio waveform, and the collection of data elements can collectively represent the audio waveform.

As another example, each data element can represent a musical note, and the collection of data elements can collectively represent a musical composition.

As another example, each data element can represent a pixel in a respective video frame of a video that includes multiple frames, and the collection of data elements can collectively represent the video.

As another example, each data element can represent a respective structure parameter from a set of structure parameters that collectively define a structure of a protein.

As another example, each data element can represent an amino acid, and the collection of data elements can collectively represent an amino acid sequence of a protein.

As another example, each data element can represent a text symbol, e.g., a character, word piece, or word, and the collection of data elements can collectively represent a piece of text, e.g., natural language text or computer code.

As another example, the target output can represent a structured output or a classification output for a network input that represents any appropriate entity.

For example, the structured output can be a semantic segmentation, instance segmentation, or a panoptic segmentation output for an image, a point cloud, or a video that assigns each data element in the input to a respective class, that assigns each data element. As another example, the structured output can be an object detection output, optical flow output, a depth prediction output, or other computer vision output for an image, a point cloud, or a video.

The classification output can be any appropriate classification output for a given entity above or other appropriate entity, e.g., an image classification output, an audio classification output, a video classification output, or a point cloud classification output, that classifies the entity into one or more of a plurality of classes.

More specifically, in an image or video classification task, the output may be an output indicating the presence of one or more object categories in the input image data. The indication may be a probability, a score or a binary indicator for a particular object category. In an object detection task, the output may be an output indicating a location of one or more objects that have been detected in the input image data. The indication may be a bounding box, set of co-ordinates or other location indicator and the output may further comprise a label indicating the corresponding detected object. In a depth estimation task, the output may be an output indicating an estimated depth of objects depicted in the image data. The output may be a depth map comprising an estimated depth value for each pixel of the input image data. The video classification task may be an action recognition task. The output may be an output indicating that one or more particular actions are being performed in the video. The output may comprise an output indicating the temporal and/or spatial location within the video that an action is being performed at.

If the input is audio data, the audio data may comprise a speech signal. The neural network may be configured to carry out an audio processing task which may be a speech processing task such as speech recognition. The output may be output data comprising one or more probabilities or scores indicating that one or more words or sub-word units comprise a correct transcription of the speech contained within. Alternatively, the output data may comprise a transcription itself. The audio processing task may be a keyword (“hotword”) spotting task. The output may be an indication of whether a particular word or phrase is spoken in the input audio data. The audio processing task may be a language recognition task. The output may provide an indication or delineation of one or more languages present in the input audio data. The audio processing task may be a control task. The input audio data may comprise a spoken command for controlling a device and the output may comprise output data that causes the device to carry out actions corresponding to the spoken command.

In some other implementations, there are multiple time steps in the sequence.

In some of these implementations, the system 100 receives a new network input at each time step in the sequence and generates a respective target output at each time step in the sequence, so that the network output at each time step defines the target output at the time step, i.e., is the target output or can be transformed into the target output. For example, the network inputs can be interdependent, so that the previous network inputs provide context for generating the target output at a given time step. In these examples, the network inputs and target outputs can be any of those described above, but with new network inputs being provided at each time step.

In others of these implementations, the system 100 iteratively generates a single target output across the multiple time steps. In these implementations, the network output 112 at the final time step defines the target output, i.e., is the target output or can be transformed into the target output.

For example, the system 100 can perform a reverse diffusion process across the multiple time steps to generate the target output.

At the first time step, the network input 102 is initialized to a noisy version of the target output, i.e., a version that has the same number of data elements as the target output but that includes at least some data elements that are sampled from a noise distribution.

At each iteration, the network input is the current version of the target output and the network output defines an estimate of the target output given the current version, e.g., is an estimate of the noise added to the target output to generate the current version or is the estimate of the target output given the current version.

The system 100 then uses the network output 112 at the iteration to update the current version of the target output, e.g., using any appropriate diffusion model state transition rule, e.g., DDIM (further details of which can be found in J. Song et al., Denoising Diffusion Implicit Models, ICLR 2021, which is hereby incorporated by reference in its entirety), DDPM (further details of which can be found in J. Ho et al., Denoising Diffusion Probabilistic Models, NeurIPS, 2020, which is hereby incorporated by reference in its entirety), or another appropriate state transition rule.

After the last iteration, the system 100 uses the updated version of the target output as the final estimate of the target output, i.e., as the target output that is provided by the system 100.

In these cases, the system 100 can generate a target output that is a collection of data elements that represent any appropriate entity, e.g., one of the entities described above, across the multiple time steps.

More generally, the system 100 can generate target outputs for any task that requires operating on tensors that include a large number of data elements, e.g., a structured prediction task that requires generating a structured output for a network input that has a large number of data elements, a generative task that requires generating a target output that has a large number of data elements (e.g. the generation of an image, video or audio signal), or a classification task that requires generating a classification output for a network input that has a large number of data elements.

In some implementations, the system 100 can be conditioned on data that specifies one or more desired characteristics of the collection of data elements to be generated by the system. A few examples of conditioning data are described next.

In one example, the conditioning data can characterize a sequence of text, and when conditioned on the conditioning data, the system 100 can generate a collection of data elements that represents a verbalization of the sequence of text. For example, the data elements may be elements (e.g. samples) of an audio signal that comprises a spoken utterance corresponding to the sequence of text.

As another example, the conditioning data can define a set of properties of a protein (e.g., stability, solubility, etc.), and when conditioned on the conditioning data, the system 100 can generate data defining a protein that is predicted to have the properties specified by the conditioning data.

As another example, the conditioning data can specify one or more features of an image or a video (e.g., an object shown in the image), and when conditioned on the conditioning data, the system 100 can generate an image or a video having the features specified by the conditioning data. The features can be specified as, e.g., a class label from a set of possible object class labels or a natural language text sequence that describes the features of the image or video.

As another example, the conditioning data can specify one or more features of a point cloud (e.g., an object characterized by the point cloud), and when conditioned on the conditioning data, the system 100 can generate a point cloud having the features specified by the conditioning data.

As another example, the conditioning data can specify one or more features of a sequence of text (e.g., a topic of the sequence of text, a question about the text, an initial portion of computer program code), and when conditioned on the conditioning data, the system 100 can generate a sequence of text having the features specified by the conditioning data.

The system 100 can implement this conditioning in any of a variety of ways.

For example, the system 100 can map the conditioning input to one or more conditioning embeddings and include the conditioning embedding(s) in the set of latent vectors, the set of interface vectors or both. The system can perform this mapping by processing the conditioning input using an embedding neural network that is appropriate for the type of conditioning input. For example, when the conditioning input is text, the embedding neural network can be a text embedding neural network, e.g., an RNN or a Transformer. For example, when the conditioning input is audio, the embedding neural network can be an audio embedding neural network, e.g., an RNN or a Transformer. For example, when the conditioning input is an image, the embedding neural network can be an image embedding neural network, e.g., a convolutional neural network or a vision Transformer.

As another example, for a task that requires generating a target output that is a completion of an initial target output that is provided to the system as a conditioning input, the system 100 can represent the network input 102 at each iteration (time step) as one or more fixed data elements that correspond to the data elements that are included in the conditioning input and a plurality of unfixed (i.e. variable) data elements that need to be completed by the system 100.

For example, the system 100 can fix one or more initial video frames that are provided as input and generate the remainder of the video frames in the video as described above. As another example, the system 100 can fix a portion of the pixel values in an image and generate the remainder of the pixel values as described above. As yet another example, the system 100 can fix a set of points from a point cloud that are provided as input and generate the remainder of the points in the point cloud as described above. As yet another example, the system 100 can fix a portion of a text sequence that is provided as input and generate the remainder of the text sequence as described above.

FIG. 2 is a flow diagram of an example process 200 for generating a network output at a time step. For convenience, the process 200 will be described as being performed by a system of one or more computers located in one or more locations. For example, a neural network system, e.g., the neural network system 100 of FIG. 1, appropriately programmed, can perform the process 200.

The system can perform the process 200 for each time step in a sequence of one or more time steps. That is, in some implementations, there is only a single time step and the system performs only a single iteration of the process 200. In other implementations, there are multiple time steps, with a respective network input at each time step as described above, and the system performs multiple iteration of the process 200 to generate a respective network output for each network input.

The system obtains a network input for the time step (step 202). Generally, as described above, the network input includes a collection of data elements.

The system generates, from at least the network input for the time step, a set of interface vectors (step 204).

For example, the system can generate a respective interface vector from each of a plurality of subsets of the collection of data elements. For example, when the network inputs are images or videos the subsets can be patches of the images or video in the network input for the time step.

For example, for each of the plurality of subsets, the system can generate the interface vector from the subset by applying one or more learned projection layers to the data elements in the subset to generate the respective interface vector for the subset.

As another example, the system can apply a different learned transformation to the data elements in the subset, e.g., a Transformer or a recurrent neural network or an MLP.

As another example, the system can process the network input using an encoder neural network, e.g., a convolutional neural network or a Transformer neural network, to generate the interface vectors.

In any of the above examples, the learned transformation, the encoder neural network, or the learned projection layers can be pre-trained prior to the training of the recurrent interface network or learned jointly with the training of the learned interface network.

The system initializes a set of latent vectors for the time step (step 206). Generally, the set of interface vectors includes a larger number of vectors than the set of latent vectors.

Moreover, as described above, the number of vectors in the set of interface vectors is dependent on the size of the network input, while the number of vectors in the set of latent vectors is fixed and independent of the size of the network input.

Generally, the system initializes at least some of the latent vectors in the set using a set of learned latent embedding vectors that are learned during the training of the recurrent interface network.

That is, the set of latent vectors includes a subset of latent vectors that are initialized using the set of learned latent embedding vectors. In some implementations, the subset is not a proper subset and all of the latent vectors are initialized using the set of learned latent embedding vectors. In some other implementations, the subset is a proper subset that includes less than all of the latent vectors, and some of the latent vectors are not initialized using the set of latent vectors.

For example, as described above, some of the latent vectors can be determined based on the conditioning input to the neural network.

As another example, when the sequence of time steps includes a plurality of time steps, at any given time step the set of latent vectors can include one or more latent vectors that represent an embedding of the given time step, i.e., that are generated by mapping an identifier for the given time step to one or more embedding vectors. The mapping can be pre-determined, e.g., sinusoidal, or can be learned during the training of the recurrent interface network.

For the subset that is initialized using the set of learned latent embedding vectors, in some implementations, the system initializes the subset of the latent vectors to be equal to the set of learned latent embedding vectors, i.e., initializes each latent vector in the subset by setting the latent vector equal to a corresponding one of the learned latent embedding vectors.

In some other implementations, when the sequence of time steps includes a plurality of time steps, at any given time step the system initializes the subset of latent vectors using latent self-conditioning.

In latent self-conditioning, the system initializes the subset of the latent vectors using a preceding set of latent vectors. The preceding set of latent vectors are the subset of the set of latent vectors for a preceding time step after being updated by the last neural network block in the sequence at the preceding time step. That is, the preceding set of latent vectors are the latent vectors (in the subset) after being updated by the last neural network block of the recurrent interface network at the preceding time step.

In particular, when using latent self-conditioning, the system initializes the subset of the latent vectors by combining the preceding set of latent vectors with the set of learned latent embeddings. For example, for each latent vector in the subset, the system can combine the corresponding preceding latent vector with the corresponding learned latent embedding to initialize the latent vector by applying one or more learned transformations to the preceding latent vector to generate a transformed latent vector and then adding the transformed latent vector and the learned latent embedding. For example, the one or more learned transformations can be a MLP with a skip connection, followed by a LayerNorm operation. The learned transformations, e.g., the MLP, can be learned during the training of the recurrent interface network. Optionally, at the outset of training, the LayerNorm operation can be initialized with zero scaling and bias, so that the set of latents is equal to the set of learned latent embeddings early in training.

Making use of latent self-conditioning allows the recurrent interface network to incorporate potentially useful context from previous time steps when performing the processing at a given time step, thereby improving the quality of outputs generated by the recurrent interface network with minimal additional computational overhead, i.e., adding only the one or more learned linear transformations.

After the interface vectors and the latent vectors have been generated, the system processes the interface vectors and the latent vectors through each neural network block in the sequence of neural network blocks within the recurrent interface network to update the set of interface vectors (step 208). As described above, each block processes the interface vectors and the latent vectors that are received as input by the block to update the interface vectors and the latent vectors.

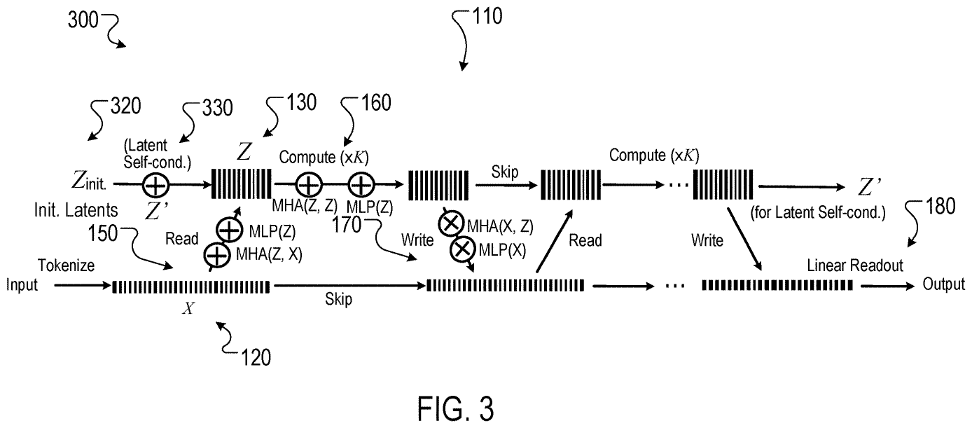

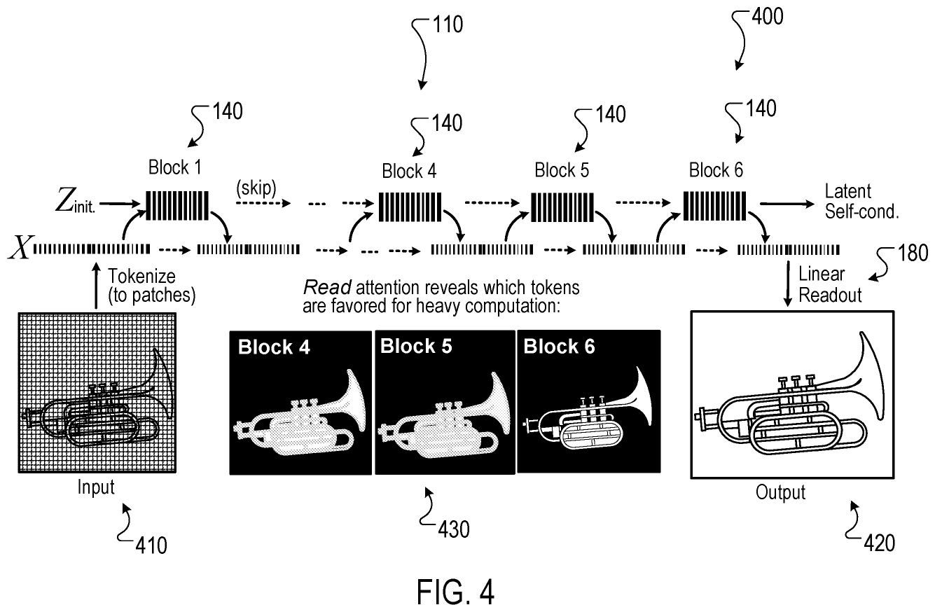

The operations performed by the blocks are described in more detail below with reference to FIGS. 3 and 4.

After processing the interface vectors and the latent vectors through the sequence of neural network blocks to update the set of interface vectors, the system processes the set of interface vectors using a readout neural network to generate a network output for the time step (step 210). As described above, the architecture of the readout neural network will generally depend on the format of the network output for the time step.

FIG. 3 shows an example 300 of a computation graph of a recurrent interface network 110 at a given time step.

As shown in FIG. 3, at the given time step the input is tokenized to form the set of interface vectors X 120. “Tokenizing” the network input at a given time step refers to dividing the network input into portions (“tokens”) and then generating a respective interface vector for each portion of the network input, e.g., by applying a learned embedding operation to each portion.

The set of latent vectors Z 130 are initialized using a set of latent embedding vectors Zᵢₙᵢₜ 320 and, optionally, using the latent vectors from the preceding time step Z′ through latent self-conditioning 330.

Each block then uses the read neural network 150 of the block to update the set of latent vectors.

In particular, in the example of FIG. 3, the read neural network 150 is configured to apply attention over the latent and the interface vectors with queries derived from the latent vectors and keys derived from the interface vectors. In the particular example of FIG. 3, the read neural network applies multi-head attention (MHA) with queries derived from the latent vectors Z and keys (and values) derived from the interface vectors X followed by an MLP on each of the latent vectors Z.

After processing the interface vectors and the latent vectors using the read neural network to update the set of latent vectors, each block processes the set of latent vectors using the process neural network 160 (with the operations performed by the process neural network 160 being referred to as the “compute” step in FIG. 3) of the block to update the set of latent vectors.

In particular, in the example of FIG. 3, the process neural network 160 is configured to apply attention over the latent vectors with keys and queries derived from the latent vectors. In the particular example of FIG. 3, the process neural network 160 includes K blocks that each apply multi-head attention (MHA) with queries, keys, and values derived from the latent vectors Z followed by an MLP on each of the latent vectors Z.

After processing the set of latent vectors using the process neural network 160 to update the set of latent vectors, each block processes the set of latent vectors and the interface vectors using the write neural network 170 of the block to update the set of interface vectors. In particular, in the example of FIG. 3, the write neural network 170 is configured to apply attention over the latent and the interface vectors with queries derived from the interface vectors and keys derived from the latent vectors. In the particular example of FIG. 3, the write neural network 170 applies multi-head attention (MHA) with keys (and values) derived from the latent vectors Z and queries derived from the interface vectors X followed by an MLP on each of the interface vectors X.

As shown in FIG. 3, while the read 150 and write 170 neural networks perform only one multi-head attention operation, the process neural network 160 can include K blocks (K compute steps) that each apply a multi-head attention operation over the latent vectors. For example, K can be equal to 4, 6, 8, or 16. Thus, the bulk of the computation of each block is dedicated to updating the latents, which are generally smaller in number than the interface vectors. In other words, while each block updates the interface vectors only one time, the same block can repeatedly update the latent vectors, ensuring that the bulk of the computation takes place in the space of latent vector space.

Multi-ahead attention (MHA) is described in more detail in, e.g., Vaswani, A., Shazeer, N., Parmar, N., Uszkoreit, J., Jones, L., Gomez, A. N., Kaiser, Ł., and Polosukhin, I. Attention is all you need. Advances in neural information processing systems, 30, 2017.

FIG. 4 shows an example 400 of using a recurrent interface network 110 with six blocks 140 to generate an image.

In particular, FIG. 4 shows one time step during the performance of a reverse diffusion process. Thus, the network input 102 at the time step is a noisy image 410 and the network output 112 defines a “denoised” image 420.

As can be seen from FIG. 4, patches of the noise image are tokenized to generate the set of interface vectors. The interface vectors are then updated using each of the six blocks 140 and a linear readout network 180 is applied to the interface vectors after being updated using the six blocks to generate the network output 112. While FIG. 4 shows the linear readout network 180 generating the denoised image 420 for ease of understanding, in practice, the linear readout network 180 can alternatively generate the estimated noise in the noisy image and the denoised image 420 can be generated from the estimated noise and the noisy image.

As shown in FIG. 4, the attention operations performed by the read networks within blocks 4, 5, and 6 assign one or more respective weights 430 to each of the interface vectors as part of performing attention. In FIG. 4, lighter shading corresponds to higher attention weights. As can be seen from FIG. 4, the attention operations assign greater weights to the more visually complex portions of the image, which are then processed using the respective update neural networks of the respective blocks, indicating that the recurrent interface networks adaptively assign computation to different parts of the input. In other words, in the example of FIG. 4, because the portions of the image that depict the musical instrument are more visually complex relative to the background, the attention operations assign greater weights to the portions of the image that depict the instruction, which ensures that the respective update neural networks of the respective blocks focus on “denoising” those portions of the image.

Prior to using the recurrent interface network, the system or a training system trains the recurrent interface network and the other learned components of the system, e.g., the learned latent embeddings, the learned transformations for latent self-conditioning, the readout network and, optionally, the learned transformations used to generate the interface vectors, jointly on training data.

Generally, the training system trains these components on training data that is appropriate for the task that the system is configured to perform and on an objective function that is appropriate for the task.

For example, when the system performs a reverse diffusion process after training, the training system can train the components on a diffusion model training objective, e.g., a score matching objective.

As another example, when the system performs a classification task, the system can train the components on a classification objective, e.g., a cross-entropy loss.

As another example, when the system performs a regression task, the system can train the components on a regression objective, e.g., a mean-squared error loss, an l2 distance loss, and so on.

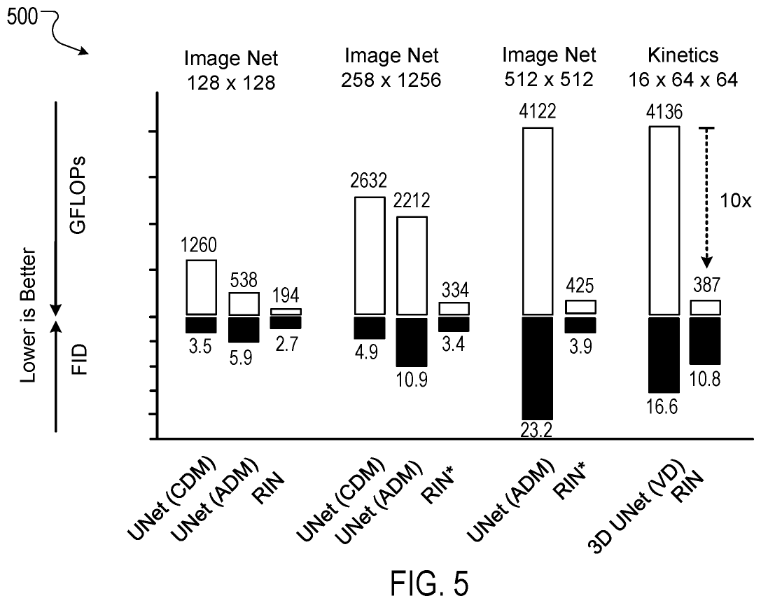

FIG. 5 shows an example 500 of the performance of the recurrent interface network when used as part of a reverse diffusion process on three image generation tasks and one video generation task. In particular, the example 500 shows the performance of a variety of techniques on these tasks in terms of GFLOPs and FID (Frechet inception distance), which is a metric that assesses the quality of an image (or video) generated by a model.

As can be seen from FIG. 5, the recurrent interface network (labeled as “RIN” in the Figure), outperforms other techniques that use U-Nets (a type of neural network architecture that is based on a convolutional neural network) while requiring significantly fewer FLOPs (floating point operations) and therefore, GLFOPs (giga floating point operations). In particular, because the bulk of the computation of the RiN is performed on the latent vectors, which are much smaller in size than the interface vectors and the data being modeled, the RiN can perform the processing with significantly fewer FLOPs and requires fewer memory resources. Moreover, because the use of the latents throughout the sequence of multiple blocks allows for bottom-up (data to latent) and top-down (latent to data) feedback, this leads to deeper and more expressive routing, allowing the RiN to outperform the other techniques, which do not have such a routing scheme.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages: and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

This specification also provides the subject-matter of the following clauses:

Clause 1. A method performed by one or more computers, the method comprising, at each time step in a sequence of one or more time steps:
obtaining a network input for the time step;
generating, from at least the network input for the time step, a set of interface vectors;
initializing a set of latent vectors for the time step;
processing the interface vectors and the latent vectors through each neural network block in a sequence of neural network blocks to update the set of interface vectors, wherein each neural network block in the sequence is configured to:
   process the interface vectors and the latent vectors using a read neural network to update the set of latent vectors;
   after processing the interface vectors and the latent vectors using the read neural network to update the set of latent vectors, process the set of latent vectors using a process neural network to update the set of latent vectors; and
   after processing the set of latent vectors using a process neural network to update the set of latent vectors, processing the set of latent vectors and the interface vectors using a write neural network to update the set of interface vectors; and
after processing the interface vectors and the latent vectors through the sequence of neural network blocks to update the set of interface vectors, processing the set of interface vectors using a readout neural network to generate a network output for the time step.

Clause 2. The method of clause 1, wherein the set of interface vectors includes a larger number of vectors than the set of latent vectors.

Clause 3. The method of clause 2, wherein a number of vectors in the set of interface vectors is dependent on a size of the network input and a number of vectors in the set of latent vectors is fixed and independent of the size of the network input.

Clause 4. The method of any one of clauses 1-3, wherein:
the sequence of time steps includes a plurality of time steps.

Clause 5. The method of clause 4, wherein initializing a set of latent vectors for the time step comprises:
initializing at least a subset of the latent vectors using a preceding set of latent vectors, wherein the preceding set of latent vectors are at least a subset of the set of latent vectors for a preceding time step after being updated by a last neural network block in the sequence at the preceding time step.

Clause 6. The method of clause 5, wherein initializing at least a subset of the latent vectors using a preceding set of latent vectors comprises:
combining the preceding set of latent vectors with a set of learned latent embeddings.

Clause 7. The method of any one of clauses 1-4, wherein initializing a set of latent vectors for the time step comprises:
initializing at least a subset of the latent vectors to be equal to a set of learned latent embedding vectors.

Clause 8. The method of clause 6 or clause 7, wherein the learned latent embeddings are learned during training of the neural network blocks in the sequence.

Clause 9. The method of any preceding clause, further comprising:
receiving a conditioning input; and
generating, from the conditioning input, one or more conditioning embedding vectors,
wherein the network output is conditioned on the conditioning embedding vectors.

Clause 10. The method of clause 9, wherein:
initializing a set of latent vectors for the time step comprises including the one or more conditioning embedding vectors in the set of latent vectors.

Clause 11. The method of clause 9 or clause 10, wherein generating a set of interface vectors for the time step comprises including the one or more conditioning embedding vectors in the set of interface vectors.

Clause 12. The method of any preceding clause, further comprising:
generating, from an identifier for the time step, one or more time step embedding vectors,
wherein the network output is conditioned on the time step embedding vectors.

Clause 13. The method of clause 12, wherein
initializing a set of latent vectors for the time step comprises including the one or more time step embedding vectors in the set of latent vectors.

Clause 14. The method of clause 12 or clause 13, wherein generating a set of interface vectors for the time step comprises including the one or more time step embedding vectors in the set of interface vectors.

Clause 15. The method of any preceding clause when dependent on clause 3, wherein:
at the first iteration of the plurality of iterations, the network input comprises a noisy version of a target output;
the network input for each time step is a current version of the target output as of the time step;
the network output for the time step defines an estimate of the target output given the current version of the target output as of the time step; and
the method further comprises, at each time step:
   updating the current version of the target output using the network output for the time step.

Clause 16. The method of clause 15, further comprising:
at a final time step of the plurality of time steps and after updating the current version of the target output using the network output for the final time step, providing, as a final estimate of the target output, the updated current version of the target output.

Clause 17. The method of clause 15 or clause 16, wherein the network output is an estimate of noise added to the target output to generate the current version of the target output as of the time step.

Clause 18. The method of clause 15 or clause 16, wherein the network output is the estimate of the target output to generate the current version of the target output as of the time step.

Clause 19. The method of any one of clauses 15-18, wherein updating the current version of the target output using the network output for the time step comprises applying a diffusion model state transition rule to at least the current version of the target output as of the time step and the network output for the time step.

Clause 20. The method of any preceding clause, wherein initializing the set of latent vectors comprising initializing the latent vectors independently from the network input for the time step.

Clause 21. The method of any preceding clause, wherein the read neural network is configured to apply attention over the latent and the interface vectors with queries derived from the latent vectors and keys derived from the interface vectors.

Clause 22. The method of any preceding clause, wherein the write neural network is configured to apply attention over the latent and the interface vectors with keys derived from the latent vectors and queries derived from the interface vectors.

Clause 23. The method of any preceding clause, wherein the process neural network is configured to apply attention over the latent vectors with keys and queries derived from the latent vectors.

Clause 24. The method of any one of clauses 21-23, wherein the attention is multi-head attention.

Clause 25. The method of any preceding clause, wherein the network input comprises a collection of data elements.

Clause 26. The method of clause 25, wherein generating, from at least the network input for the time step, a set of interface vectors comprises:
generating a respective interface vector from each of a plurality of subsets of the collection of data elements.

Clause 27. The method of clause 26, wherein generating a respective interface vector from each of a plurality of subsets of the collection of data elements comprises, for each of the plurality of subsets, applying one or more learned projection layers to the data elements in the subset to generate the respective interface vector for the subset.

Clause 28. The method of any preceding clause, wherein, at each time step, the network input comprises one or more fixed data elements and a plurality of unfixed data elements, and wherein the network output at the time step defines an estimate of a completion of the unfixed data elements given at least the fixed data elements.

Clause 29. A system comprising:
one or more computers; and
one or more storage devices communicatively coupled to the one or more computers, wherein the one or more storage devices store instructions that, when executed by the one or more computers, cause the one or more computers to perform operations of the respective method of any one of clauses 1-24.

Clause 30. One or more non-transitory computer storage media storing instructions that when executed by one or more computers cause the one or more computers to perform operations of the respective method of any one of clauses 1-24.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising, at each time step in a sequence of one or more time steps:
obtaining a network input for the time step;
generating, from at least the network input for the time step, a set of interface vectors;
initializing a set of latent vectors for the time step;
processing the interface vectors and the latent vectors through each neural network block in a sequence of neural network blocks to update the set of interface vectors, wherein each neural network block in the sequence is configured to:
process the interface vectors and the latent vectors using a read neural network to update the set of latent vectors;
after processing the interface vectors and the latent vectors using the read neural network to update the set of latent vectors, process the set of latent vectors using a process neural network to update the set of latent vectors; and
after processing the set of latent vectors using the process neural network to update the set of latent vectors, processing the set of latent vectors and the interface vectors using a write neural network to update the set of interface vectors; and
after processing the interface vectors and the latent vectors through the sequence of neural network blocks to update the set of interface vectors, processing the set of interface vectors using a readout neural network to generate a network output for the time step.

2. The method of claim 1, wherein the set of interface vectors includes a larger number of vectors than the set of latent vectors.

3. The method of claim 2, wherein a number of vectors in the set of interface vectors is dependent on a size of the network input and a number of vectors in the set of latent vectors is fixed and independent of the size of the network input.

4. The method of claim 1, wherein:
the sequence of time steps includes a plurality of time steps.

5. The method of claim 4, wherein initializing a set of latent vectors for the time step comprises:
initializing at least a subset of the latent vectors using a preceding set of latent vectors, wherein the preceding set of latent vectors are at least a subset of the set of latent vectors for a preceding time step after being updated by a last neural network block in the sequence at the preceding time step.

6. The method of claim 5, wherein initializing at least a subset of the latent vectors using a preceding set of latent vectors comprises:
combining the preceding set of latent vectors with a set of learned latent embeddings.

7. The method of claim 1, wherein initializing a set of latent vectors for the time step comprises:
initializing at least a subset of the latent vectors to be equal to a set of learned latent embedding vectors.

8. The method of claim 6, wherein the learned latent embeddings are learned during training of the neural network blocks in the sequence.

9. The method of claim 1, further comprising:
receiving a conditioning input; and
generating, from the conditioning input, one or more conditioning embedding vectors,
wherein the network output is conditioned on the conditioning embedding vectors.

10. The method of claim 9, wherein:
initializing a set of latent vectors for the time step comprises including the one or more conditioning embedding vectors in the set of latent vectors.

11. The method of claim 9, wherein generating a set of interface vectors for the time step comprises including the one or more conditioning embedding vectors in the set of interface vectors.

12. The method of claim 1, further comprising:
generating, from an identifier for the time step, one or more time step embedding vectors,
wherein the network output is conditioned on the time step embedding vectors.

13. The method of claim 12, wherein
initializing a set of latent vectors for the time step comprises including the one or more time step embedding vectors in the set of latent vectors.

14. The method of claim 12, wherein generating a set of interface vectors for the time step comprises including the one or more time step embedding vectors in the set of interface vectors.

15. The method of claim 3, wherein:
at the first iteration of the plurality of iterations, the network input comprises a noisy version of a target output;
the network input for each time step is a current version of the target output as of the time step;
the network output for the time step defines an estimate of the target output given the current version of the target output as of the time step; and
the method further comprises, at each time step:
updating the current version of the target output using the network output for the time step.

16. The method of claim 15, further comprising:
at a final time step of the plurality of time steps and after updating the current version of the target output using the network output for the final time step, providing, as a final estimate of the target output, the updated current version of the target output.

17. The method of claim 15, wherein the network output is an estimate of noise added to the target output to generate the current version of the target output as of the time step.

18. The method of claim 15, wherein the network output is the estimate of the target output given the current version of the target output as of the time step.

19. The method of claim 1, wherein updating the current version of the target output using the network output for the time step comprises applying a diffusion model state transition rule to at least the current version of the target output as of the time step and the network output for the time step.

20. The method of claim 1, wherein initializing the set of latent vectors comprising initializing the latent vectors independently from the network input for the time step.

21. The method of any claim 1, wherein the read neural network is configured to apply attention over the latent and the interface vectors with queries derived from the latent vectors and keys derived from the interface vectors.

22. The method of claim 1, wherein the write neural network is configured to apply attention over the latent and the interface vectors with keys derived from the latent vectors and queries derived from the interface vectors.

23. The method of claim 1, wherein the process neural network is configured to apply attention over the latent vectors with keys and queries derived from the latent vectors.

24. The method of claim 21, wherein the attention is multi-head attention.

25. The method of claim 1, wherein the network input comprises a collection of data elements.

26. The method of claim 25, wherein generating, from at least the network input for the time step, a set of interface vectors comprises:
generating a respective interface vector from each of a plurality of subsets of the collection of data elements.

27. The method of claim 26, wherein generating a respective interface vector from each of a plurality of subsets of the collection of data elements comprises, for each of the plurality of subsets, applying one or more learned projection layers to the data elements in the subset to generate the respective interface vector for the subset.

28. The method of claim 1, wherein, at each time step, the network input comprises one or more fixed data elements and a plurality of unfixed data elements, and wherein the network output at the time step defines an estimate of a completion of the unfixed data elements given at least the fixed data elements.

29. A system comprising:
one or more computers; and
one or more storage devices communicatively coupled to the one or more computers, wherein the one or more storage devices store instructions that, when executed by the one or more computers, cause the one or more computers to perform operations comprising, at each time step in a sequence of one or more time steps:
obtaining a network input for the time step;
generating, from at least the network input for the time step, a set of interface vectors;
initializing a set of latent vectors for the time step;
processing the interface vectors and the latent vectors through each neural network block in a sequence of neural network blocks to update the set of interface vectors, wherein each neural network block in the sequence is configured to:
process the interface vectors and the latent vectors using a read neural network to update the set of latent vectors;
after processing the interface vectors and the latent vectors using the read neural network to update the set of latent vectors, process the set of latent vectors using a process neural network to update the set of latent vectors; and
after processing the set of latent vectors using the process neural network to update the set of latent vectors, processing the set of latent vectors and the interface vectors using a write neural network to update the set of interface vectors; and
after processing the interface vectors and the latent vectors through the sequence of neural network blocks to update the set of interface vectors, processing the set of interface vectors using a readout neural network to generate a network output for the time step.

30. One or more non-transitory computer storage media storing instructions that when executed by one or more computers cause the one or more computers to perform operations comprising, at each time step in a sequence of one or more time steps:
obtaining a network input for the time step;
generating, from at least the network input for the time step, a set of interface vectors;
initializing a set of latent vectors for the time step;
processing the interface vectors and the latent vectors through each neural network block in a sequence of neural network blocks to update the set of interface vectors, wherein each neural network block in the sequence is configured to:
process the interface vectors and the latent vectors using a read neural network to update the set of latent vectors;
after processing the interface vectors and the latent vectors using the read neural network to update the set of latent vectors, process the set of latent vectors using a process neural network to update the set of latent vectors; and
after processing the set of latent vectors using the process neural network to update the set of latent vectors, processing the set of latent vectors and the interface vectors using a write neural network to update the set of interface vectors; and
after processing the interface vectors and the latent vectors through the sequence of neural network blocks to update the set of interface vectors, processing the set of interface vectors using a readout neural network to generate a network output for the time step.
